(19) United States
(12) Patent Application Publication
(10) Pub. No.: US 2019/0319662 A1
(43) Pub. Date: Oct. 17, 2019

(54) BUMPER TAPE AND BUMPER FOR PROTECTING HAND-HELD ELECTRONIC DEVICES

(71) Applicant: Michael B. ARMSTRONG, White Rock (CA)

(72) Inventor: Michael B. ARMSTRONG, White Rock (CA)

(21) Appl. No.: 16/373,184

(22) Filed: Apr. 2, 2019

(30) Foreign Application Priority Data
Apr. 13, 2018 (CA) 3001573

(51) Int. Cl. H04B 1/3888; C09J 7/20

(52) U.S. Cl. CPC H04B 1/3888; C09J 7/20

(57) ABSTRACT

A protective elastomeric bumper for use with a hand-held electronic device is provided, the bumper comprising: a band, which has a perimeter, the perimeter defining an inner space, the band including an inner surface, an outer surface, and a plurality of apertures extending from the outer surface to the inner surface and continuous with the inner space and an ambient environment, the outer surface including one or more of a central ridge or a pair of outer ridges which extend around the perimeter, the inner surface including a central valley, which extends around the band; and an adhesive, the adhesive located in the central valley.

### CROSS REFERENCE TO RELATED APPLICATIONS

This application claims benefit of Canadian Patent Application Serial No. 3,001,573, filed on Apr. 13, 2018, entitled BUMPER TAPE AND BUMPER FOR PROTECTING HAND-HELD ELECTRONIC DEVICES, the contents of which are incorporated herein by reference.

### FIELD

The present technology is a stretchable bumper for fitting around the perimeter of hand-held electronic devices. More specifically it is a one size fits all bumper for cell phones.

### BACKGROUND

There are a number of protective cases available for a variety of cellular phones, tablets and other portable consumer electronic devices. In general, they are purpose built in that they only fit a specific make and model of the portable electronic devices. Some cases are constructed from a simple silicon or thermoplastic polyurethane rubber molding that provides some basic protection against drops and scratches. Others are constructed from hard injected plastic such as polycarbonate (PC) and provide similar protection. Cases are typically attached to the device through some mechanical means that seeks to impose a semi-permanent marriage of the case and the device.

The design and construction of the existing cases provide various levels of protection while also exhibiting various consumer features and benefits, as well as tradeoffs in use as viewed by the typical consumer. For example, rubber cases are economical and they provide basic protection against light drops and scratches. However, the rubber can often provide excessive unwanted grip, which makes insertion and removal of the device into a pants pocket or small purse difficult. Rubber cases also tend to be bulky in design and do not lend themselves well to storage in tight spaces such as a pocket or small purse.

Conversely, depending on the design, hard plastic injection molded cases can often provide superior protection while facilitating easy insertion and retrieval from a pocket. Furthermore, these cases tend to impose a lower profile upon the device resulting in an overall smaller form factor which is desirable if the device is to be carried in a pocket or small purse. However, the hard cases provide little cushioning.

United States Patent Application 20100246113 discloses an electronic device 60 comprising a flexible display arranged to be alternated between a collapsed state and an extended state, said flexible display comprising edge portions, the flexible display being further provided with an edge protector cooperating with the edge portions, wherein the edge protector is conceived to be alternated between a collapsed state and an extended state. In the electronic device 60a the flexible display 65 is conceived to be wound about a roller 61. The edge protector comprises rigid segments 63a, 63b, 63c, 62a, 62b, 62c, 62c interconnected by suitable means 64a, 64b, 64c. Wiring, pins, bars may be used for interconnecting means 64a, 64b, 64c. In the embodiment 60a an extended position of the edge protector is shown. In the embodiment 60b a collapsed state of the edge protector is shown comprising aggregations of segments 62′, 62″. The bars 64a, 64b, 64c partly protect the back surface of the display. The invention further relates to the electronic device comprising a flexible display wherein the flexible display is provided with an edge protector attached at least partially to the edge portions of the flexible display. The edge protector is rigid and segmented. It would be specific to the make and model of cell phone. Further, it would be bulky.

United States Patent Application 20060081496 discloses a plastic edge protector for protecting corner regions of objects during shipping or transport includes a pair of generally perpendicularly oriented legs or walls, and a reinforced corner region which prevents damage to the object and the protector. The edge protector is formed so as to include a solid interior wall or bead of plastic which extends along the entire longitudinal extent of the edge protector. These are not for use with cell phones and if used for a cell phone, would have to be specific to the make and model.

United States Patent Application 20170063423 discloses a cell phone case cover having four layer system screen protector including a first polyethylene terephthalate (PET) layer, an optically clear adhesive (OCA) layer, a second polyethylene terephthalate (PET) layer and a silicon adhesive layer in combination with a protective case body constructed to protect the phone and allow to activate touch screen capabilities on side positioned curved screen displays. As these have a rigid body, they would be customized for each model of cell phone. Further to this, the cases are bulky.

United States Patent Application 20170036416 discloses conformable protection pads with a reinforcing layer. Included are cell phone cases. As these have a rigid body, they would be customized for each model of cell phone. Further to this, the cases are bulky.

United States Patent Application 20160377139 discloses a vibration reducing assembly including a flexible headgear and at least one panel of vibration reducing material secured to the flexible headgear. The at least one panel of vibration reducing material includes at least a first elastomer layer and a reinforcement layer comprising a high tensile strength fibrous material. The material is disclosed to be used in cell phone protective cases. The panel is rigid and therefore the cases would be specific to the make and model of cell phone. Further to this, the resultant case would be bulky.

United States Patent Application 20150068934 discloses a composite case for an electronic device is provided. The composite case includes: a resilient portion dimensioned to cover two end portions of the electronic device and less than half of a back portion of the electronic device; and a rigid portion dimensioned to fit with the resilient portion, the rigid portion dimensioned to provide a cover for at least part of the back portion of the electronic device. A method of protecting an electronic device is provided. The method includes: attaching a rigid material to a resilient material; dimensioning both the rigid material and the resilient material to contain an electronic device; configuring the rigid material, but not the resilient material, to cover most or all of a back portion of the electronic device; and providing an opening to allow a screen portion of the electronic device to be accessed through the opening in the rigid and resilient material. As these have a rigid body, they would be customized for each model of cell phone. Further to this, the cases are bulky.

United States Patent Application 20070225031 discloses a case for a portable electronic device such as cell phones, cameras, MP3 players and PDAs wherein said case includes material at the corners to provide protection to the electronic device. To reduce bulk at the corners and allow the material forming the case to conform with the contours of the device, the protection at the corners includes strips of material defining apertures there between. The apertures provide reduction in bulk and allow the case to conform to the corners of the device therein. Alternately, the protection at the corners can be provided by other structures co-molded into the corners of the cases. Such structures include material that is of a reduced thickness than other material used in the case, or structures that are formed to conform to the corners of the case. Such structures can be joined to the material forming the panels of the case by co-molding.

United States Patent Application 20070296853 discloses a snug, form fitting skin for a consumer electronic device to protect against trauma like dust, dirt, scratches and water. There is additionally disclosed a rigid housing for such skin-encased device. It needs to be customized for each model of cell phone. Further to this, the case is bulky.

RhinoShield's CrashGuard® is a one-piece bumper that fits over the edges of the phone. While the bumper has some flexibility, it is only sufficient to allow it to be fitted over the phone. The bumpers are specific to the make and model of phone and have predefined apertures for alignment with buttons and ports of the phone. https://rhinoshieldio/pages/main-page/Apple?device=iphone-7-plus&category=crashguard&prod=iphone-7-plus-bumper-case

Utomic® provides corner bumpers that stick on and edge protectors that appear to slide on. These are specific to the make and model of the phone. https://www.utomic.com/collections/edge

What is needed is a bumper that can be used with a wide range of makes and models of mobile electronic devices. It would be preferable if the bumper was provided with a plurality of apertures such that the controls and ports were readily accessible independent of make and model. It would be preferable if the bumper was made of a stretchable material to allow for differences in device sizes and shapes. It would be preferable if the bumper could be provided as a spooled product that can be cut to a selected length. It would be preferable if the bumper and/or tape was universal, or at least could be fit to a wide range of makes and models of portable electronic devices. This would reduce waste in landfills.

### SUMMARY

The present technology is a bumper that can be used with a wide range of makes and models of mobile electronic devices. The bumper is provided with a plurality of apertures such that the controls and ports are readily accessible independent of make and model. The bumper is made of a stretchable material to allow for differences in device sizes and shapes. The bumper is provided as a spooled product (a tape) that can be cut to a selected length. The tape is universal.

In one embodiment, a protective elastomeric bumper for use with a hand-held electronic device is provided, the bumper comprising: a band, which has a perimeter, the perimeter defining an inner space, the band including an inner surface, an outer surface, and a plurality of apertures extending from the outer surface to the inner surface and continuous with the inner space and an ambient environment, the outer surface including one or more of a central ridge or a pair of outer ridges which extend around the perimeter, the inner surface including a central valley, which extends around the band; and an adhesive, the adhesive located in the central valley.

In the bumper, the band may have an elastic deformation of about 140% to about 200%.

In the bumper, the band may have a Young's Modulus of about 0.001 to about 0.08 GigaPascals (GPa).

In the bumper, the central valley may include two substantially vertical walls and a bottom, each wall and the bottom defining a corner.

In the bumper, the adhesive may be located in the corners of the central valley.

In the bumper, the band may consist of a silicone rubber.

In the bumper, the band may be a lattice.

In another embodiment, a combination comprising a hand-held electronic device and a protective elastomeric bumper is provided, the hand-held electronic device comprising a front, a back and sides extending between the front and the back, the sides including at least one control button, the front and sides defining front edges and the back and sides defining back edges, the bumper comprising: a band, which has a perimeter, the perimeter defining an inner space, the band including an inner surface, an outer surface, and a plurality of apertures extending from the outer surface to the inner surface and continuous with the inner space and an ambient environment, the outer surface including one or more of a central ridge or a pair of outer ridges which extend around the perimeter, the inner surface including a central valley, which extends around the band, and in which the front edges, the back edges and the sides of the hand-held electronic device are retained; and an adhesive, the adhesive located in the central valley.

In the combination, the at least one control button may be at least partially aligned with one of the plurality of apertures.

In the combination, the hand-held electronic device may include a camera, the camera aligned with one of the plurality of apertures.

In the combination, the hand-held electronic device may include at least one port, the port aligned with one of the plurality of apertures.

In the combination, the hand-held electronic device may be a cell phone.

In the combination, the band may have an elastic deformation of about 140% to about 200%.

In the combination, the band may have a Young's Modulus of about 0.001 to about 0.08 GigaPascals (GPa).

In the combination, the band may consist of a silicone rubber.

In the combination, the band may be a lattice.

In another embodiment, protective elastomeric tape for use with a hand-held electronic device is provided, the tape comprising: a length; an upper surface; a lower surface; a plurality of apertures extending from the upper surface to the lower surface and continuous with an ambient environment, the lower surface including a central valley, which extends along the length; and an adhesive, the adhesive located in the central valley.

In the tape, the upper surface may include one or more of a central ridge or a pair of outer ridges which extend the length.

The tape may have a Shore A durometer rating of about 15A to about 35A.

In the tape, the tape may have an elastic deformation of about 140% to about 200%.

In the tape, the tape may have a Young's Modulus of about 0.001 to about 0.08 GigaPascals (GPa).

In the tape, the central valley may include two substantially vertical walls and a bottom, each wall and the bottom defining a corner.

In the tape, the adhesive may be located in the corners of the central valley.

In the tape, the tape may consist of a silicone rubber.

In the tape, the tape may be a lattice.

In yet another embodiment, a protective elastomeric band for use with a hand-held electronic device is provided, the band comprising: a perimeter, the perimeter defining an inner space; an inner surface, the inner surface including a central valley which extends around the band; an outer surface; and a plurality of apertures extending from the outer surface to the inner surface and continuous with the inner space and an ambient environment.

The band may have a Shore A durometer rating of about 15A to about 35A.

### FIGURES

FIG. 1A is a perspective view of a cell phone bumper on a cell phone;

FIG. 1B is a schematic of the bumper.

FIG. 2A is a schematic of a matrix of an alternative cell phone bumper.

FIG. 2B is a schematic of a matrix of an alternative cell phone bumper.

FIG. 2C is a schematic of a matrix of an alternative cell phone bumper.

FIG. 2D is a schematic of a matrix of an alternative cell phone bumper.

FIG. 3A is a perspective cross sectional view of the cell phone bumper of FIG. 1;

FIG. 3B is an alternative embodiment of FIG. 3A.

FIG. 4A is a perspective view of a tablet bumper on a tablet;

FIG. 4B is a schematic of the bumper.

FIG. 5 is a side view of a tape on a dispenser.

FIG. 6A is a schematic of a matrix of an alternative tape.

FIG. 6B is a schematic of a matrix of an alternative tape.

FIG. 6C is a schematic of a matrix of an alternative tape.

FIG. 6D is a schematic of a matrix of an alternative tape.

FIG. 7A is a perspective cross sectional view of the tape;

FIG. 7B is an alternative embodiment of FIG. 7A.

FIG. 8A is a schematic of the tape being applied to the edges of a hand-held device;

FIG. 8B is a schematic of the same tape forming a bumper around the perimeter of the hand-held device;

FIG. 8C is a schematic of the tape formed into the bumper.

### DESCRIPTION

Except as otherwise expressly provided, the following rules of interpretation apply to this specification (written description and claims): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, the terms “comprising,” “having,” “including,” and “containing” are to be construed as open ended terms (i.e., meaning “including, but not limited to,”) unless otherwise noted.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

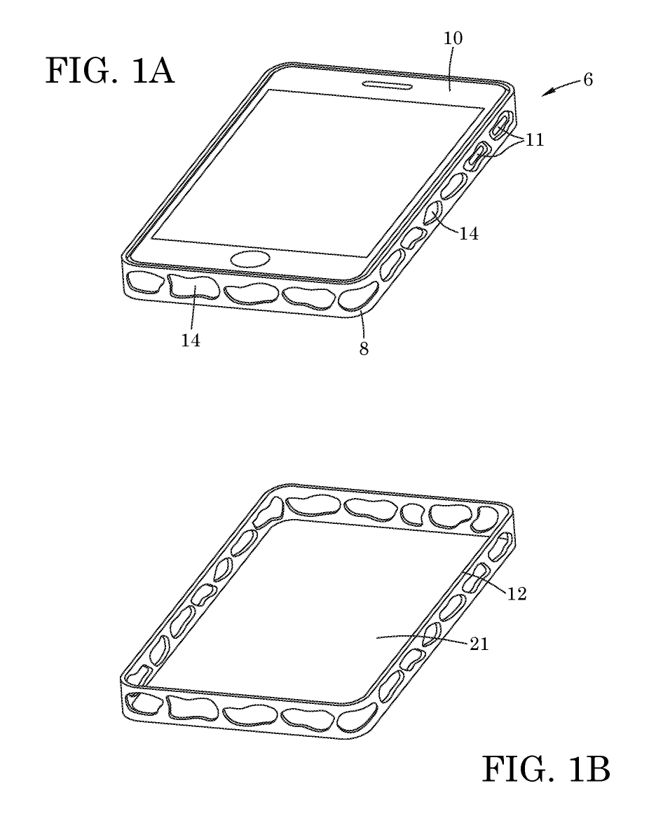

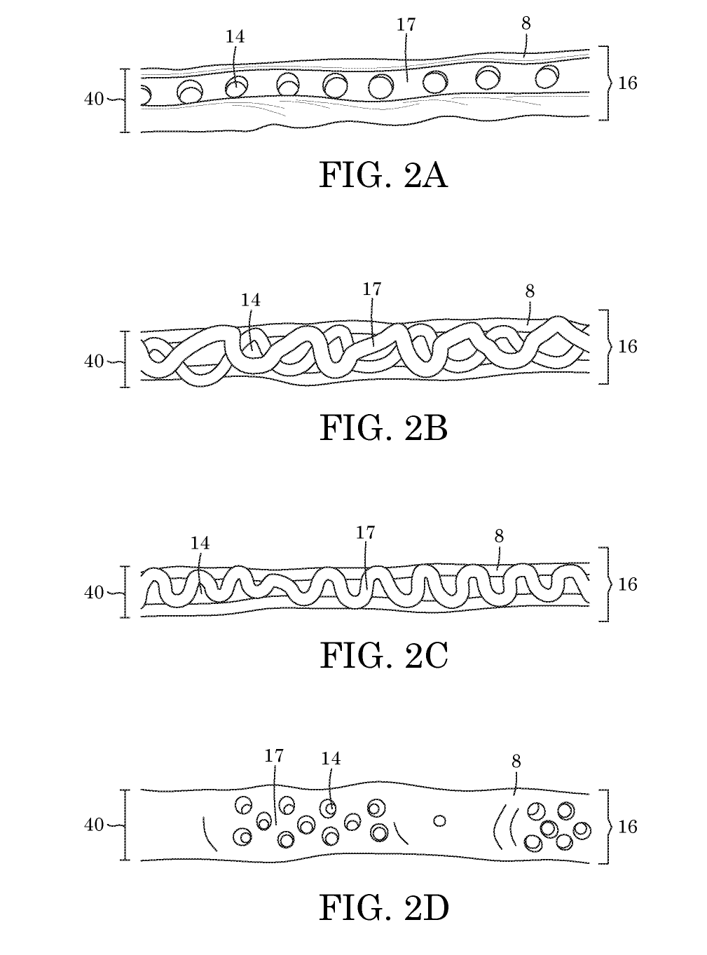

In FIG. 1, a cell phone bumper, generally referred to as 6, is shown on a cell phone 10. The bumper 6 has a band 8 that defines a perimeter 12. The band 8 has a plurality of apertures 14 that extend through the bumper 6 to expose ports, controls and the camera, collectively referred to as 11, of the cell phone 10 to the ambient. As shown in FIG. 2, the apertures 14 can be in any shape and can be arranged in any pattern to form a lattice or matrix 16. The apertures 14 can be random in their placement. Further, the shapes of the apertures 14 can be random. As the bumper 6 is elastomeric and there are many apertures 14, for example at least three times more apertures than there are ports, controls and the camera, for example, but not limited to at least 24 apertures, there is no need to align the apertures 14 with the ports or controls. In other words, the combination of a high ratio of aperture to elastomer, and the flexibility of the elastomer allow a user to press the location of a port or control and have it actuated, without necessarily having direct access to the port or control.

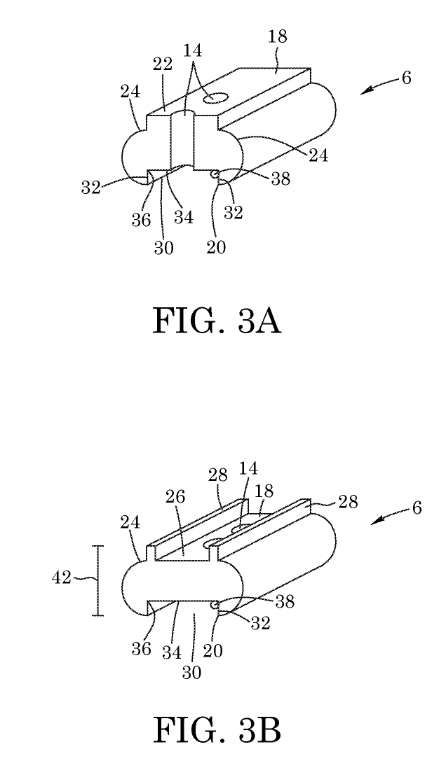

To be clear, as shown in FIG. 3A, the apertures 14 extend from the ambient through the bumper 6 to the inner space 21 defined by the perimeter 12 (FIG. 1B). The outer surface 18, in the preferred embodiment, has a central ridge 22 with a shoulder 24 on either side. Returning to FIG. 2A-D, the lattice 16 is made of strands 17 and the ridge 22 seen in FIG. 3A is formed where the strands 17 intersect. In an alternative embodiment, as shown in FIG. 3B, the outer surface 18 of FIG. 3A is reconfigured to have a central groove 26 with an outer ridge 28 on either side. In either embodiment, the inner surface 20 has a central valley 30 which is about the width of the central ridge 22 or central groove 26. The central valley 30 has side walls 32 which are vertical or near vertical and a bottom 34, with a corner 36 between the side walls 32 and the bottom 34. An adhesive 38 is located in each corner 36 and runs substantially the perimeter 12 of the bumper 6. The adhesive 38 may be dotted along the length, or may be continuous along the length, as it need only be sufficient to adhere the inner surface 30 to the perimeter of the cell phone. The adhesive 38 may be, for example, but not limited to pieces of double sided tape, dots of glue, or a continuous length of glue. As shown in FIG. 2A-D, the band 8 is about 1 cm to about 2 cm in width 40, preferably 1.5 cm in width 40. As shown in FIG. 3B the bumper 6 is about 0.5 to about 0.8 cm in depth 42, preferably about 0.7 cm in depth 42. The central ridge 22 and the ridges 28 (collectively referred to as an elongate protrusions) function to absorb shock. The width 40 of the bumper 6 is greater than the width of the cell phone 10, thus it extends beyond the upper and lower edges of the cell phone 10. This also allows the bumper 6 to absorb shock and to protect the cell phone 10.

The band 8 is made of silicone rubber and has a Young's Modulus of about 0.001 to about 0.05 or about 0.08 GigaPascals (GPa). In an alternative embodiment, it is made of a different elastomer that has a Young's Modulus of about 0.001 to about 0.05 or about 0.08 GigaPascals (GPa). The silicone rubber or the alternative elastomer preferably stretches, within its elastic deformation, to at least about 140% to about 200% of its original length (plastic elongation of 347%), preferably about 150% of the original length while the width is reduced by about 40% to about 70% or about 50%. This allows the band 8 to be stretched around the sides of the cell phones 10 and to fit a number of different designs and models of phones. The silicone rubber or an alternative elastomer that would be used in the body has a Shore A durometer rating of about 15A to about 35A, preferably about 20A to about 30A and most preferably 20A.

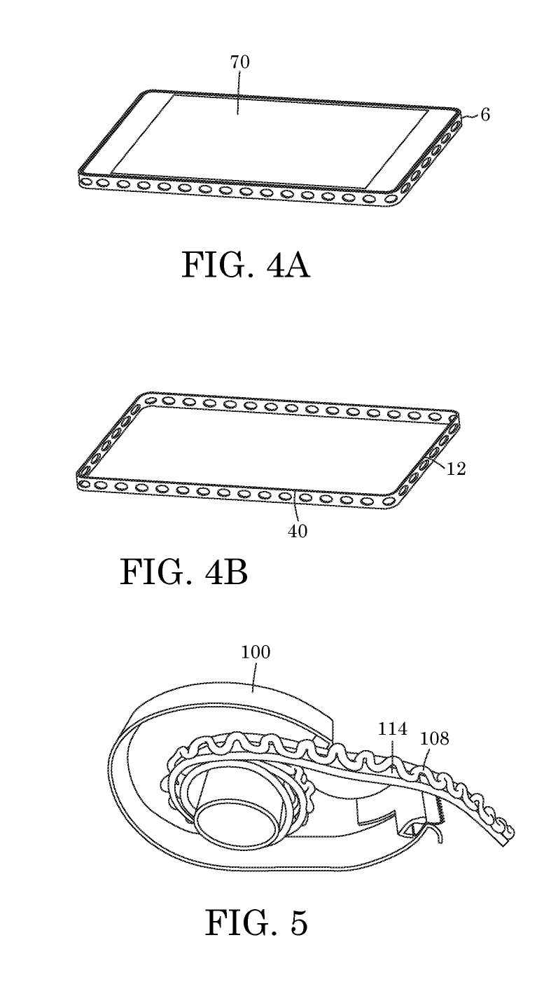

As shown in FIG. 4, in an alternative embodiment, the bumper 6 is sized to fit around the perimeter of a tablet 70. As would be known to one skilled in the art, the bumper 6 can be sized to fit around the perimeter of other hand-held electronic devices, including but not limited to remote controls, game controllers and the like. The perimeter 12 and width 40 of the bumper 6 are sized to extend around the perimeter and to be raised above and below the upper and lower edges of the device.

In use, the appropriate bumper 6 is selected base on the depth of the device. The ratio of the width of the bumper 8 selected to the depth of the device is about 2.5:1 to about 1.4:1 or about 2:1 and all ratios therebetween. This allows the bumper 6 to be stretched along its perimeter, while still being wide enough for the sides of the device to be nested in the central valley 30.

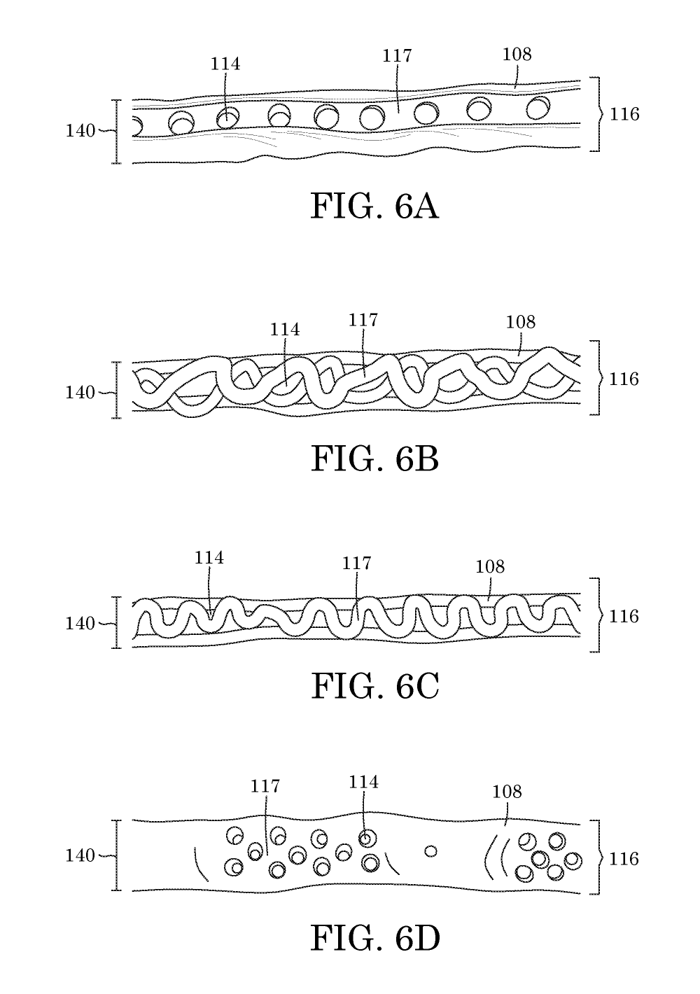

In FIG. 5, a tape, generally referred to as 108, is shown on a dispenser 100. The tape 108 has a plurality of apertures 114 that extend through the tape 108 for exposing ports, camera and controls of the cell phone 10 to the ambient or the infrared of a remote control 10 to the ambient. As shown in FIG. 6A-D, the apertures 114 can be in any shape and can be arranged in any pattern to form a matrix or lattice 116. The apertures 114 can be random in their placement. Further, the shapes of the apertures 114 can be random. As the tape 108 is elastomeric and there are many apertures 114, there is no need to align the apertures 114 with the ports or controls. In other words, the combination of a high ratio of aperture to elastomer, and the flexibility of the elastomer allow a user to press the location of a port or control and have it actuated, without necessarily having direct access to the port or control.

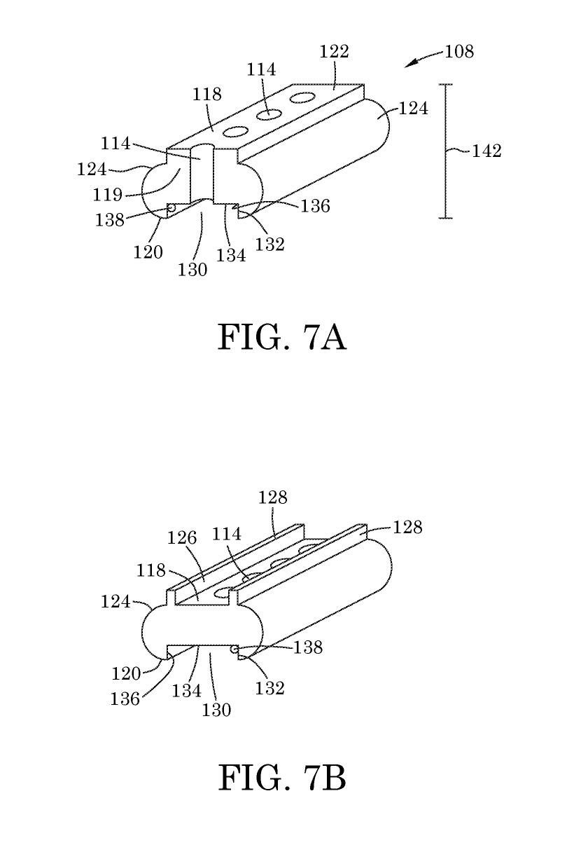

To be clear, as shown in FIG. 7A, the apertures 114 extend from the outer surface 118 through the body 119 of the tape 108 to the inner surface 120. The outer surface 118, in the preferred embodiment, has a central ridge 122 with a shoulder 124 on either side. Returning to FIG. 6A-D, the lattice 116 is made of strands 117 and the ridge 122 seen in FIG. 7A is formed where the strands 117 intersect. In an alternative embodiment, as shown in FIG. 7B, the outer surface 118 has a central groove 126 with an outer ridge 128 on either side. In either embodiment, the inner surface 120 has a central valley 130 which is about the width of the central ridge 122 or central groove 126. The central valley 130 is sized to accept the sides of the selected electronic hand-held device. The central valley 130 has side walls 132 which are vertical or near vertical and a bottom 134, with a corner 136 between the side walls 132 and the bottom 134. The tape 108 can be provided as a roll or on the dispenser 100. The inner surface 120 and the outer surface 118 of both embodiments nest together, with the embodiment of FIG. 7A forming a tight fit. An adhesive 138 is located in each corner 136 and runs substantially the perimeter 112 of the tape 108. The adhesive 138 may be dotted along the length, or may be continuous along the length, as it need only be sufficient to adhere the inner surface 130 to the perimeter of the hand-held device 110. The adhesive 138 may be, for example, but not limited to pieces of double sided tape, dots of glue, or a continuous bead of glue. As shown in FIG. 6A-D, the tape 108 is about 1 cm to about 2 cm in width 140, preferably 1.5 cm in width 140 for a cell phone, about 1 cm to about 3 cm in width 140, preferably 2 cm in width 140 for a tablet and about 2 cm to about 3 cm in width 140, preferably 2.5 cm in width 140 for a remote controller. As shown in FIG. 7A, the tape is about 0.5 to about 0.8 cm in depth 142, preferably about 0.7 cm in depth 142. For a tablet, the depth may be greater, for example, about 0.7 to about 1.2 cm in depth. The central ridge 122 and the ridges 128 (collectively referred to as an elongate protrusions) function to absorb shock. The width 140 of the tape 108 is greater than the width of the mobile or hand-held electronic device 110, thus it extends beyond the upper and lower edges of the device 110. The length 150 and width 140 of tape 108 are selected to extend around the perimeter of the device 110. This also allows the tape 108 to absorb shock and to protect the device 110.

The body 119 of the tape 108 is made of silicone rubber and has a Young's Modulus of about 0.001 to about 0.05 or about 0.08 GigaPascals (GPa). In an alternative embodiment, it is made of a different elastomer that has a Young's Modulus of about 0.001 to about 0.05 or about 0.08 GigaPascals (GPa). The silicone rubber or the alternative elastomer preferably stretches, within its elastic deformation, to at least about 140% to about 200% of its original length (plastic deformation of 347%), preferably about 150% of the original length while the width is reduced by about 40% to about 70% or about 50%. The silicone rubber or an alternative elastomer that would be used in the body has a Shore A durometer rating of about 15A to about 35A, preferably about 20A to about 30A and most preferably 20A.

In use, the appropriate tape 108 is selected base on the depth of the device. The ratio of the width of the tape 108 selected to the depth of the device 110 is about 2.5:1 to about 1.4:1 or about 2:1 and all ratios therebetween. This allows the tape 108 to be stretched along its length, while still being wide enough for the sides of the device to be nested in the central valley 130.

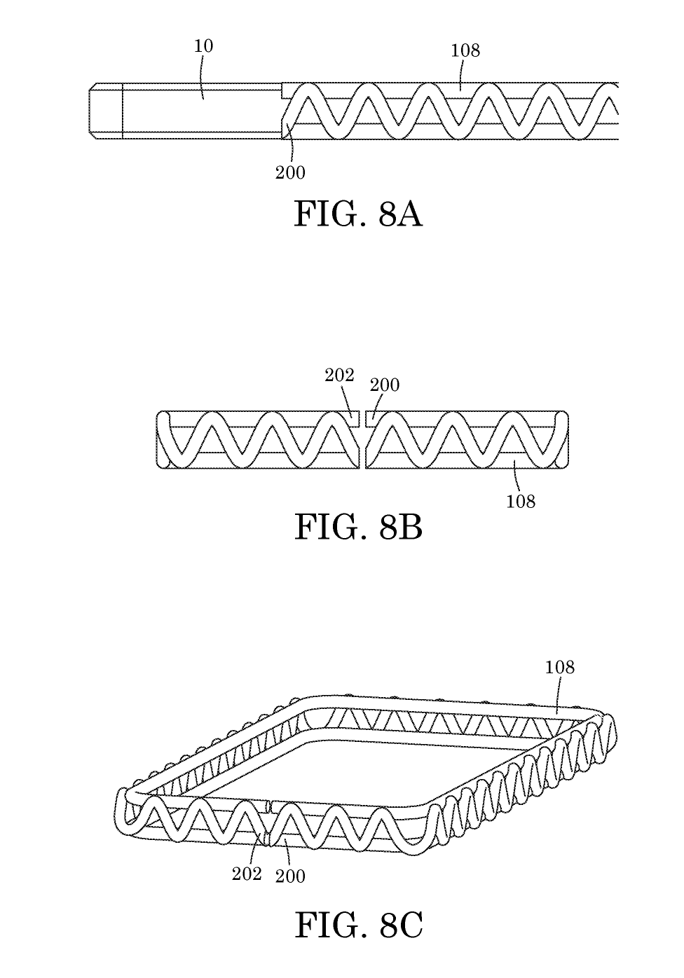

The tape 108 is dispensed from the dispenser 110 to provide a length having a ratio of length of tape 108 to perimeter of the device 10 of about 0.6:1 to about 0.75:1 and all ratios therebetween. The tape 108 is cut to that length. In one approach, the first end 200 of the tape is attached to the device as shown in FIG. 8A and is then stretched around the perimeter of the device such that the second end 202 abuts the first end 200, as shown in FIG. 8B thus providing a protective bumper for the device. Note that the tape extends above and below the edges of the device. In alternative approach, the first end 200 and the second end 202 abut one another and are glued, affixed, annealed or otherwise attached to each other to provide the bumper, as shown in FIG. 8C. The bumper is then stretched and placed over the perimeter of the device, as shown in FIGS. 1 and 4.

In an alternative embodiment, the tape 108 has a plurality of apertures 114 that extend through the tape 108 for exposing ports and controls of the cell phone 10 to the ambient or the infrared of a remote control 10 to the ambient. As shown in FIG. 6, the apertures 114 can be in any shape and can be arranged in any pattern to form a matrix or lattice 116. To be clear, as shown in FIG. 7A, the apertures 114 extend from the outer surface 118 through the body 119 of the tape 108 to the inner surface 120. The outer surface 118 has a shoulder 124 on either side. The inner surface 120 has an adhesive 138 on at least a part of the surface. The outer surface 118 lacks a central ridge 122 and lacks a central groove 126 with an outer ridge 128 on either side. In either embodiment, the inner surface 120 lacks a central valley 130.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize or be able to ascertain using no more than routine experimentation, many equivalents to the specific example embodiments specifically described herein. Such equivalents are intended to be encompassed in the scope of the claims, if appended hereto or subsequently filed.

1. A protective elastomeric bumper for use with any one of a wide range of hand-held electronic devices, the hand-held electronic devices including a sidewall, the bumper comprising: a band, which has a perimeter, the perimeter defining an inner space, the band including an inner surface, an outer surface, and a plurality of randomly shaped and positioned apertures extending from the outer surface to the inner surface and continuous with the inner space and an ambient environment, the outer surface including one or more of a central ridge or a pair of outer ridges which extend around the perimeter, the inner surface including a central valley, which extends around the band; and an adhesive, the adhesive located in the central valley.

2. The bumper of claim 1, wherein the band has an elastic deformation of about 140% to about 200%.

3. The bumper of claim 2, wherein the band has a Young's Modulus of about 0.001 to about 0.08 GigaPascals (GPa).

4. The bumper of claim 3, wherein the central valley is configured to nest the hand-held electronic device sidewalls.

5. The bumper of claim 4, wherein the adhesive is located in the corners of the central valley.

6. The bumper of claim 5, wherein the band consists of a silicone rubber.

7. The bumper of claim 6, wherein the band is a lattice.

8. A combination comprising any one of a wide range of hand-held electronic devices and a protective elastomeric bumper, the hand-held electronic device comprising a front, a back and sides extending between the front and the back, the sides including at least one control button, the front and sides defining front edges and the back and sides defining back edges, the bumper comprising: a band, which has a perimeter, the perimeter defining an inner space, the band including an inner surface, an outer surface, and a plurality of randomly shaped and positioned apertures extending from the outer surface to the inner surface and continuous with the inner space and an ambient environment, the outer surface including a central ridge which extends around the perimeter, the inner surface including a central valley, which extends around the band, and in which the front edges, the back edges and the sides of the hand- held electronic device are retained; and an adhesive, the adhesive located in the central valley.

9. The combination of claim 8, wherein the at least one control button is at least partially aligned with one of the plurality of apertures.

10. The combination of any one of claim 9, wherein the hand-held electronic device is a cell phone.

11. The combination of claim 9, wherein the band has an elastic deformation of about 140% to about 200%.

12. A protective, universal elastomeric tape for use with any one of a wide range of hand-held electronic devices, the tape comprising: a length; an upper surface which includes a central ridge extending the length; a lower surface which includes a central valley extending the length, the central ridge sized to nest in the central valley; a plurality of randomly shaped and positioned apertures extending from the upper surface to the lower surface and continuous with an ambient environment; and an adhesive, the adhesive located in the central valley.

13. The tape of claim 12, wherein the tape has an elastic deformation of about 140% to about 200%.

14. The tape of claim 12, wherein the tape has a Young's Modulus of about 0.001 to about 0.08 GigaPascals (GPa).

15. The tape of claim 12, wherein the tape has a Shore A durometer rating of about 15A to about 35A.

16. The tape of claim 15, wherein the central valley includes two substantially vertical walls and a bottom, each wall and the bottom defining a corner.

17. The tape of claim 16, wherein the adhesive is located in the corners of the central valley.

18. The tape of claim 17, wherein the tape consists of a silicone rubber.

19. The tape of claim 18, wherein the tape is a lattice.

20. A protective, universal elastomeric bumper for use with any one of a wide range of cell phones, the cell phones including a sidewall, the bumper comprising: a band, which has a perimeter, the perimeter defining an inner space, the band including an inner surface, an outer surface, and a plurality of randomly shaped and positioned apertures extending from the outer surface to the inner surface and continuous with the inner space and an ambient environment, the outer surface including one or more of a central ridge or a pair of outer ridges which extend around the perimeter, the inner surface including a central valley, which extends around the band, wherein the central valley is configured to nest the sidewall; and an adhesive, the adhesive located in the central valley.
